(19) United States
(12) Patent Application Publication
(10) Pub. No.: US 2002/0067443 A1
(43) Pub. Date: Jun. 6, 2002

(54) Phosphor arrangement for liquid-crystal displays

(76) Inventors: Paul A. Bayley, Hereford (GB); Ian D. Springle, Congleton (GB)

Correspondence Address: NIXON & VANDERHYE P.C., 8th Floor, 1100 North Glebe Road, Arlington, VA, 22201, US

(21) Appl. No.: 09/972,192

(22) Filed: Oct. 9, 2001

Related U.S. Application Data
(63) Continuation of application No. 09/786,264.
Application No. 09/786,264 is a 371 of international application No. PCT/GB99/02917, filed on Sep. 3, 1999.

(30) Foreign Application Priority Data
Sep. 4, 1998 (GB) 9819359.2

(51) Int. Cl. G02F 1/1335

(52) U.S. Cl. 349/61

(57) ABSTRACT

A photoluminescent liquid-crystal display includes a liquid crystal (31) sandwiched between two transparent substrates (1, 21) for modulating input light, control electrodes (13, 23) for controlling the liquid crystal, and display output means incorporating a photoluminescent material (3) such as a phosphor for producing a visible image from the input light modulated by the liquid crystal. The phosphor is at the inner face (16) of the front substrate (1) but is sepraated from the liquid-crystal by a thin transparent auxiliary substrate (7) having a thickness of less than about 300 μm. This allows the phosphors to be close to the liquid-crystal layer (31), minimising crosstalk, without interfering with the electro-optic properties of the device.

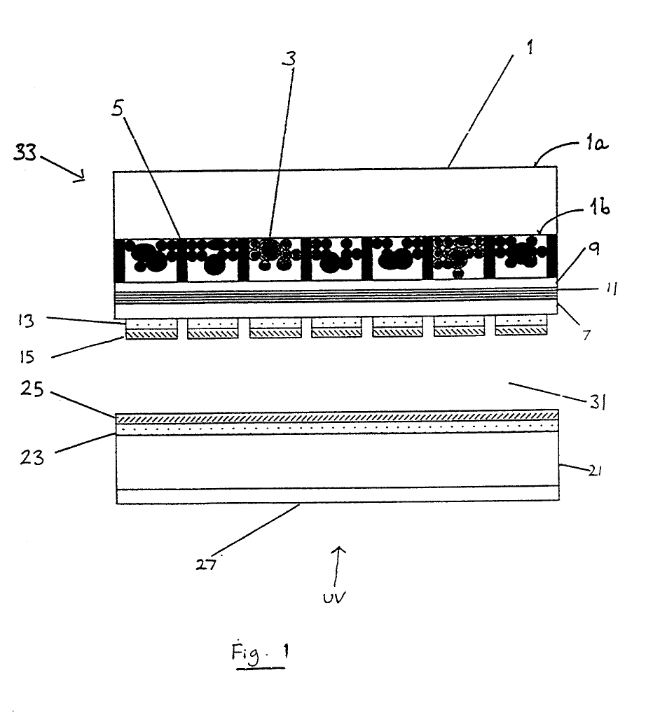

The invention relates to a liquid-crystal display (LCD), in particular to a photoluminescent liquid-crystal display, known as a PLLCD.

PLLCD devices modulate excitation light, typically ultra-violet (UV) light, using a liquid crystal (LC).

The UV light that passes through the LC is projected onto photoluminescent phosphors located on the front face of the device. In the simplest case, the phosphors are positioned on the front face of an assembled LCD panel with a substantially collimated near-UV backlight at the rear of the device, as described for instance in WO 95/27920 (Crossland et al.). However, using such a simple arrangement, the UV light passing through the LC layer must also traverse the thickness of the front glass plate of the cell before impinging upon the phosphor pixels. This glass. may be up to about 1.1 mm in thickness, a common glass thickness for standard LCD production. To achieve a high-resolution PLLCD, the phosphor pixels must be very small and very densely packed. In such an arrangement, there is a possibility that the UV light (if not perfectly collimated) may be projected not only onto the desired phosphor pixel, but also onto the adjacent phosphor pixel. This effect is commonly referred to as cross-talk and leads to a ‘blurring’ of the displayed image. Moreover, in the case of cross-talk between phosphor pixels of different colour, the blurring will be accompanied by some de-saturation of the observed colour.

There are various conceivable routes to avoiding, or at least reducing, the level of cross-talk in a PLLCD.

The first method is to improve the collimation of (TV) excitation light or eliminate the excitation light travelling towards the phosphor screen at high angles. This will also improve the overall contrast ratio of the device, since the activating light will be restricted to a range of directions through the LC cell that offer high contrast. However, high levels of collimation are typically only achieved by wasting a significant amount of the available light from the source.

Another method is to decrease the size of the electrodes of the liquid crystal, typically made of indium tin oxide (ITO), relative to the size of the phosphor pixels. See for instance WO97/25650. The ratio of ITO electrode size to phosphor pixel size necessary for total elimination of cross-talk will be determined by the divergence of the activating light and the distance between the electrodes and the phosphors. This will reduce the size of the aperture through which the UV light can pass and therefore reduce the efficiency of the device.

Thirdly, it is possible to increase the distance between adjacent phosphor pixels and to provide a large-area black matrix around the phosphor dots. The activating light that does not hit the phosphor will then be incident on black absorbent material rather than activating the adjacent phosphor pixel. This will reduce the size of the phosphor pixel itself and the UV light incident on the black mask will be wasted, thereby again reducing efficiency.

Thus, all these approaches to reducing cross-talk have associated disadvantages, usually in terms of efficiency.

According to one aspect of the invention there is provided a photoluminescent liquid-crystal display, including a liquid crystal for modulating input light, sandwiched between two transparent substrates, control electrodes for controlling the liquid crystal, and display output means incorporating a photoluminescent material or the like, for producing a visible image from the input light modulated by the liquid crystal, wherein the photoluminescent material is at the inner face of the front substrate but is separated from the liquid-crystal by a thin transparent auxiliary substrate having a thickness of less than 300 μm.

The arrangement according to the invention has the advantage that the distance between the photoluminescent pixels and the liquid-crystal layer is reduced, which significantly reduces the cross-talk between adjacent pixels, without incurring the disadvantages of prior-art arrangements having phosphor pixels physically inside the liquid-crystal cell. For instance, a previous patent application (WO 97/40416) described ways in which the phosphors could be incorporated inside the LC cell, including methods for planarisation of the resulting phosphor layer. However, even organic photoluminescent materials or phosphor particles bound in organic material are not easy to make flat, and furthermore the deposition can interfere with the electrode and alignment layers which also need to be deposited on the inside of the front glass.

A further problem with “in-cell phosphors” is that, to achieve a display with high brightness and contrast and to avoid ‘halo’ effects, the luminescent layer must be deposited on the inside of the front glass substrate in such a way that total internal reflection of the light within the device is minimised. High levels of total internal reflection will occur for example when a luminescent material is bound to a glass substrate using a binder that possesses a refractive index similar to the glass. If this is the case, a significant amount of the light from the phosphors reaching the front glass/air interface will be incident at angles higher than the critical angle for that interface. This light will be reflected back into the glass substrate towards the luminescent layer and may emerge from the substrate elsewhere following a scattering event. This is often apparent as a ‘halo’ of light around the emitting pixel.

To overcome this difficulty, the photoluminescent material, preferably a phosphor, is preferably arranged in a layer, or is separated from the main front substrate by a layer, having a refractive index lower than that of the transparent substrates. The most convenient, and cheap, such substance is air. It is possible to achieve this in devices of the present type, because the auxiliary substrate allows the provision of an air gap.

An air gap significantly reduces the halo effect, as will now be explained. Some light is emitted by the photoluminescent material perpendicular to the substrate. This light can pass through the substrate to the viewer and causes no difficulty. However, photoluminescent materials are typically diffuse emitters, and some light will be emitted at significant angles to the perpendicular, both forwards and backwards. Most of this diffuse light will pass through air before reaching either the front or the auxiliary substrate, and so upon reaching the glass surface (from the air) it will be efficiently refracted into the glass substrate. Within the glass, the refracted light will be within a range of angles such as to substantially avoid internal reflection at the front (viewer side) glass/air interface (since otherwise it would not have entered the glass), and hence the halo effect will be reduced. The majority of the light will be refracted out of the glass, offering the full viewing angle characteristics of the diffuse emitter. As will be appreciated, the same effect can be obtained with other materials having a low refractive index as well as using air.

A further benefit of using a thin substrate is that it reduces crosstalk between the pixels caused by imperfectly collimated light, while preserving a smooth internal surface for the liquid-crystal cell.

The phosphors are usually deposited with a binder, which should be burnt off to leave the phosphor in a layer of lower refractive index and reduce the halo effect as described above. Burning off a binder is known from the field of the manufacture of cathode-ray tubes. However, it has not been possible to burn off the binder in prior-art internal-phosphor displays (as described in WO 97/40416) because the binder has been necessary to cause the phosphor to adhere adequately to a substrate, unlike the high-vacuum environment of a cathode-ray tube in which a weaker bond is sufficient and it is also possible to provide a layer covering the phosphors. The burning off of phosphor binders is only possible in a liquid-crystal device as a result of the arrangement of the present invention in which the phosphor is sandwiched by two substrates, which means that it is not necessary to deposit electrodes, alignment layers or planarisation layers directly on the phosphor. The resin used to embed the phosphor in some prior-art devices has a refractive index comparable to that of glass: such a resin is thus insufficient to reduce the halo effect significantly.

Furthermore, the thin substrate acts as an excellent planarisation layer, and can support additional optical components such as a polariser layer, the phosphors being sandwiched between the polariser and the front plate.

The thickness used is a trade-off between adequate strength and the goal of reducing the distance between liquid crystal and phosphor. For strength, typical substrates should be at least 30 μm, preferably 70 μm, thick. However, the improvements achieved by the present invention are small above 300 μm; preferably the thickness should be less than 250 μm or even 150 μm.

The reduction in distance between the phosphors and the liquid crystal by using the thin auxiliary substrate leads to a reduction in cross talk for a given size of pixel. However, the finite thickness of the auxiliary substrate (plus the thickness of a polariser and visible reflector filter, if used) means that the possibility of cross talk is not completely removed. This is especially the case when the pixels are small and very closely packed. For this reason, even with the auxiliary substrate arrangement, it may be necessary to collimate the activating light to some extent, for example as described in PCT filing PCT GB95/00770, in order to achieve the required minimum level of cross talk. It may also be necessary for some level of collimation to be used in order to achieve the required level of contrast from the LCD.

As an example of the collimation requirement for resolution purposes, consider a 0.2 mm thick auxiliary substrate with 0.3 mm² pixels and 50 μm inter-pixel gaps. With no collimation, light modulated by a LC pixel will extend to cover an approximately circular area with a radius of about five times the pixel width. A collimation level of approximately ±21° would eliminate all cross talk, limiting the light modulated by each LC pixel to within a single corresponding phosphor pixel.

The auxiliary substrate can conveniently be made of glass or plastics material; such thin glass substrates are known as microsheet layers.

The thin transparent substrate can be spaced away from the front transparent substrate by ribs, which preferably define individual pixels corresponding to those of the liquid-crystal modulator. The phosphors can be provided between the ribs: these phosphors should be red, green and blue for a colour display. The ribs act as structural supports, and can also stop light emitted from one phosphor dot being transmitted to a neighbouring pixel and reducing contrast and resolution. The ribs can be UV- and visible-absorbing (black) to eliminate stray light; alternatively reflective ribs (e.g. chromium) could be used. To fix the thin substrate to the front substrate, adhesive is preferably applied, either on the ribs or at the edges of the substrates.

There may further be provided a visible-light-reflecting stack and/or a polarizer between the thin transparent substrate and the phosphors, where these components are required by the type of liquid crystal chosen.

A polarizer is preferably provided on the rear of the rear transparent substrate, where required by the type of liquid crystal e.g. for TN, STN. Electrodes, such as transparent ITO electrodes, and alignment layers can be provided on the inner surfaces, adjacent to the liquid crystal, of the rear transparent substrate and the thin transparent substrate.

According to a second aspect of the invention there is provided a method of manufacture of a liquid crystal device, comprising the steps of providing photoluminescent material on a front transparent substrate, depositing front electrodes on a thin transparent substrate having a thickness of between 30 μm and 250 μm, fixing the thin transparent. substrate to the front transparent substrate so that the photoluminescent material is sandwiched between the substrates and the electrodes are on an external surface, providing a rear transparent substrate having rear electrodes, positioning the front substrate, spaced apart from the rear substrate, with the front and rear electrodes facing inwards, and filling the space between the electrodes with liquid crystal.

A specific embodiment of the invention will now be described, purely by way of example, with reference to the accompanying drawing which shows a schematic structure of a PLLCD device according to the invention.

The primary aim is to reduce the distance between the phosphor pixels and the liquid-crystal switching layer. For this a layer of ‘micro-sheet’ glass (^{˜}50 to 200 μm thickness, for example 100 μm) is used to separate the phosphor pixels from the ITO electrodes within the cell.

The construction is divided into two substrates. To prepare the first substrate, a sheet of glass 1 standard thickness (1.1 mm, say) is used to support the phosphors 3. The thick front glass plate 1 is coated with RGP phosphor dots 3 using any suitable technique depending on the resolution required. For example PVA slurry can be used; this can be photo-sensitive and can therefore be patterned using photolithography.

The phosphor dots are surrounded by a matrix of black ribs 5 that sit proud of the phosphors 3 and will support a micro-sheet glass 7 above the phosphors. Reflective material, such as chromium, could also be used. The ribs are deposited either before or after the deposition of the phosphors 3. The ribs 5 form structural supports to attach the phosphor screen assembly to the thin glass 7 (see below). Also, they stop light emitted from phosphor dots 3 scattering through to the adjacent pixels, which could significantly impair the achievable screen contrast. If the ribs 5 are UV absorbing, they will eliminate stray UV light. Similar rib-type constructions are used for plasma display panels, or plasma-addressed liquid-crystal displays.

The phosphor binders deposited with the phosphors 3 must be removed, for example burnt off, to avoid internal reflections within the substrate; burning off provides an “air gap” between the phosphors and glass, as described above. This process takes place preferably after the formation of the matrix 5.

To prepare the microsheet glass assembly, firstly a dielectric stack 11 is coated onto the micro-sheet glass 7 to transmit collimated UVA, and reflect visible light, as described for instance in U.S. Pat. No. 4,822,144 (US Philips). A polariser 9 (for example dichroic or cholesteric) is then coated onto or under the dielectric stack 11 or onto the other side of the micro-sheet glass 7 if the electro-optic effect used requires an analyser and/or polariser.

ITO is then coated onto the micro-sheet glass 7 (or onto whatever layer has previously been coated onto it) on the side that will be adjacent to the liquid crystal 31. The ITO is patterned as required to form electrodes 13. An alignment layer 15 may be deposited on top of the ITO layer and patterned together with the ITO.

Planarisation or polishing steps may be used if necessary to ensure surface uniformity, although the micro-sheet glass should be an excellent planarisation layer itself.

The micro-sheet of glass 7 is then bound to the front glass plate 1 by adhesive applied to the surface of the black ribs, or at the edges of the glass sheets, in a similar method to that used for plasma-addressed liquid crystal displays. The first, front, substrate assembly 33 is then complete.

The second, rear, substrate is prepared in a known way by taking a glass substrate 21 (for example 1.1 mm thick) and depositing ITO electrodes 23 and an alignment layer 25 on its inner face. A polariser 27 is attached to the outer face of the rear substrate.

The display is then finished by aligning the front substrate assembly 33 (with the microsheet 1l) and the rear substrate 21 and providing a nematic liquid crystal between the front substrate assembly 33 and the rear substrate.

In use, UV light is applied through the polariser 27 at the rear of the device, modulated by the liquid crystal 31 and resolved by the front polariser 9. The phosphors 3 then absorb the UV light that is passed by the liquid-crystal shutter and respond by emitting visible light to form an image. Because the phosphors are close to the liquid crystal (say 100μ), in relation to the pixel spacing (say 250μ), few problems arise in connection with off-normal incident activating light. Also little light from the phosphors is totally internally reflected at the viewer-side surface la of the main front substrate 1, because of the air gap between the phosphor particles 3 and the lower surface 1b of the front substrate 1.

The dielectric stack 11 functions as a visible-reflective filter in close proximity to the phosphors. It reflects light emitted backwards by the phosphors forwards towards the viewer to increase brightness. The light used to excite the phosphors is at a different wavelength and can pass through the stack.

A description of dielectric stacks and their manufacture may be found in JP 7-043 528. The stacks can be made for instance of alternating layers of Ta₂O₅ and SiO₂ or MgF₂. Indeed, a stack is currently commercially available, offered by OCLI as a UV transmission (and visible-blocking) filter. At normal incidence UV is passed up to a cut-off (50%), little visible light above this wavelength passing through the filter. As the angle of incidence increases the cutoff wavelength becomes progressively shorter. Small modifications of the design can be made to optimise the of the transmission edge with respect to the UVA phosphor emission characteristic, whilst retaining broad-band visible reflection. For instance, it would be useful to have the left-hand cut-off (50%) for normal incidence at about 395 nm instead of 405 nm, when using activating light at 385 nm±10 nm.

1. A photoluminescent liquid-crystal display, including a liquid crystal for modulating input light, sandwiched between two transparent substrates (1, 21), control electrodes for controlling the liquid crystal, and display output means incorporating a photoluminescent material (3) or the like, for producing a visible image from the input light modulated by the liquid crystal, wherein the front (viewer-side) substrate comprises a main substrate (1) and a thin auxiliary substrate (7), the photoluminescent material being at the inner face of the main front substrate and separated from the liquid crystal by the auxiliary substrate.

2. A display according to claim 1, in which the auxiliary substrate has a thickness of less than 300 μm.

3. A display according to claims 1 or 2, in which the main (1) and auxiliary (7) substrates are made of glass or plastic.

4. A display according to any preceding claim, in which the photoluminescent material is divided into regions or pixels separated by a matrix (5) which supports the auxiliary substrate (7).

5. A display according to any preceding claim and further including a visible light reflecting, activating light transmitting filter (11) and/or a polarizer (9), where the components can be positioned in any order and on either or both sides of the auxiliary substrate (7).

6. A display according to claim 5, in which the visible light reflecting filter is comprised of a thin film dielectric stack.

7. A display according to any preceding claim, and further including a means of collimating the activating light.

8. A display according to any preceding claim, in which the photoluminescent material is separated from the main front substrate (1) by a gap or a layer having a refractive index lower than that of the said substrate.

9. A display according to any preceding claim, in which the photoluminescent material is a fluorescent or phosphorescent material.

10. A method of manufacture of a liquid-crystal device, comprising the steps of: providing photoluminescent material (3) on a main front transparent substrate (1), depositing front electrodes (13) on a thin transparent substrate (7), fixing the thin substrate to the main substrate so that the photoluminescent material (3) is sandwiched between the substrates and the electrodes are on an external surface, providing a rear transparent substrate (21) having rear electrodes (23), positioning the assembled front substrate so that it is spaced apart from the rear substrate, with the front and rear electrodes facing inwards, and filling the space between the electrodes with liquid crystal.

11. A method according to claim 10, in which the photoluminescent material is deposited in a binder which is subsequently removed.
